(19) United States
(12) Patent Application Publication
(10) Pub. No.: US 2002/0073936 A1
(43) Pub. Date: Jun. 20, 2002

(54) Comfort trainer

(76) Inventor: Miriam Fields-Babineau, Stafford, VA (US)

Correspondence Address: LOWE HAUPTMAN GILMAN & BERNER, LLP, Suite 310, 1700 Diagonal Road, Alexandria, VA, 22314, US

(21) Appl. No.: 09/736,408

(22) Filed: Dec. 15, 2000

(51) Int. Cl. A62B 35/00

(52) U.S. Cl. 119/863

(57) ABSTRACT

The present invention is a training halter for dogs having either regular elongated muzzles or brachiocephalic (short nosed) muzzles. This dog training device replaces collars of all types, and uses pressure on top of the dog's muzzle guiding him instead of dragging or hurting him. The trainer simply turns the dog's head in the direction he/she wishes to go and the dog follows. This training device is used in conjunction with humane and positive training methods, utilizing communication techniques instead of force.

### FIELD OF THE INVENTION

The present invention relates to animal training and restraint devices such as halters, muzzles and other collars on leashes used in the training and control of canines.

### BACKGROUND OF THE INVENTION

Training halters are used to bend a dog's actions to the master's will. The idea is to cause the dog to voluntarily comply and avoid the physical tug-of-war that occurs when the dog wants to go in a different direction than its master or wants to move faster or slower than the master. Beyond the simple leash and collar, which engenders this type of contest, there are currently in use choking collars, which are simply a canine version of the hangman's noose and inwardly spiked collars which when tugged by the leash causes the dog to prefer to acquiesce to the master's wishes rather than suffer the pain of the spikes digging into its neck.

Both the choking collar and the spiked collar are based on the infliction of pain to restrain the dog, and are looked upon by some as being inhumane. In addition, they may not be very effective, first, because the directional guidance provided the dog somewhat rough and second because the dog will respond in inverse proportion to the thickness of its pelt at the neck.

Currently, there are five head training holders available on the market that have stressed function over comfort; the K9 Kumalong, Gentle Leader, BeHave, Snoot Loop and Halti. All five head halters use nylon strapping with abrasive edges. The connectors used on these training halters are snap-on devices which are adjustable. As the head halter is used, the nylon strap over the dog's muzzle has a tendency to irritate. It rubs off the fur and can cause reddening of the skin. The Gentle Leader, in particular, rests just below the eyes and can cause swelling of the eye lids. As these devices are used, the back adjuster tends to slip looser and looser, making one have to pause in the training process to tighten. It is difficult for a dog to open its mouth to pant or drink. These devices also choke high on the neck in order to stay on.

There is thus a need for a device which will more accurately direct the dog, and will do so without irritating the skin or fur of the dog.

### SUMMARY OF THE INVENTION

It is an object of the present invention to provide a dog training halter that does not irritate the dog's nose.

It is another object of the present invention to provide a dog training halter that uses softer and less abrasive materials that do not irritate the dog's fur or skin.

The present invention is directed to a dog training device that guides the dog's head into a desired position, thereby turning his body. It guides the dog without force or pain, unlike with a choke chain or prong collar, and teaches the dog to follow its leader.

The present invention is a training halter for dogs having either regular elongated muzzles or brachiocephalic (short nosed) muzzles. The training halter replaces collars of all types, and uses pressure on top of the dog's muzzle thereby guiding him instead of dragging or hurting him. The trainer simply turns the dog's head in the direction he/she wishes to go and the dog follows. The training halter is used in conjunction with humane and positive training methods, utilizing communication techniques instead of force.

The present invention provides comfort for the dog, in the form of a softer material, with rounded edges and more attractive design. In addition, the training halter has a means of allowing more minute adjustments in the neck strap, also offering a non-slipping connection.

Also, when other conventional head halters are utilized and the canine wearer pulls off the nose piece, the entire head halter can slip off, thereby having the possibility of losing the dog. This does not happen with the present invention. If the nose piece is pulled off, it remains around the dog's neck until the handler can push the nose piece back over the nose. The material is more elastic than the nylon strapping used in other head halters.

The training halter according to the present invention provides comfort, in the form of a softer material, with rounded edges and more attractive design. This is especially critical in the nose area where the present invention utilizes a soft cotton/nylon braid in a cylindrical shape which is comfortable for the dog and prevents rubbing of the fur and reddening of the skin. In addition, the training halter has a means of allowing more minute adjustments in the neck strap. Additionally, and advantageously, the present invention uses a flat nylon braid strap for preventing chafing of the dog's fur and skin.

These and other objects of the present invention are achieved by a training halter for a dog including an upper nose loop for applying pressure to the dog's nose, a lower nose loop connected to the upper nose loop, a collar member for encircling the dog's head, and a pair of side members for securing the collar member to the upper and lower nose loops.

The training halter according to the present invention is comprised of a nose loop, side supports, under jaw, under chin strap and strap around the back of the ears. This dog training device is comprised of flat, hollow braided nylon for the side pieces, head piece and under jaw/under chin pieces; lofted, nylon draw cord (soft cotton nylon braid) for the nose piece; and a flat nylon strap for the collar (behind the ear strap). All the parts are flat with rounded edges, except the nose piece which is round. The nylon draw cord is ¼ inches to ½ inch in diameter, depending on the halter size. The flat hollow nylon braid is ½ inch wide on the sides, under jaw, under chin and under nose. The piece behind the ears is 3/16 inch to ½ inch, depending on halter size. Each piece is connected via a 20-22 millimeter welded metal (either steel or aluminum) ring, except for the under chin and jaw pieces which are sewn together. A padded nose piece can be added for dogs with extremely sensitive muzzles. This padded nose piece is made of felt.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a perspective view of a training halter according to the present invention;

FIG. 2 is the training halter in use on a canine;

FIG. 3 is a detailed view of the loop; and

FIG. 4 is an alternate embodiment of a brachiocephalic training halter.

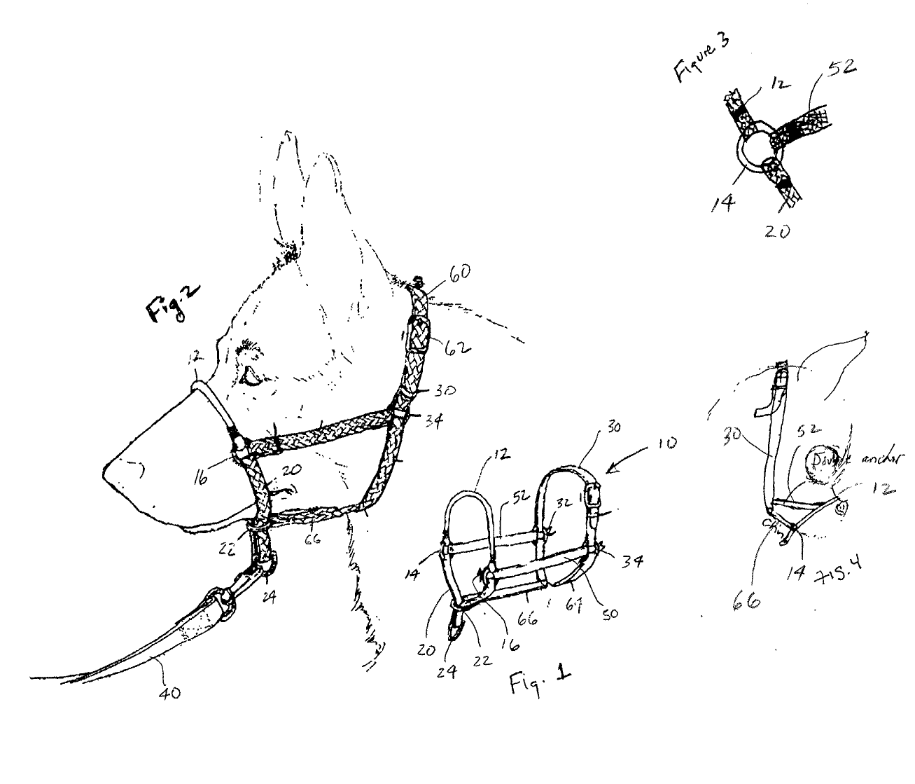

### BEST MODE FOR CARRYING OUT THE INVENTION FIG. 1 shows a first embodiment of a dog halter 10 according to the present invention. FIG. 2 shows the halter in use on a dog.

An upper nose loop 12 is attached to rings 14 and 16 at opposite ends of the nose loop 12. The nose loop 12 is made of soft cotton/nylon braid and is cylindrical. All other straps are flat braided nylon weaves. The loops or rings can be either metal or hard plastic.

An under nose loop 20 has a cinch ring 22. The under nose loop 20 is connected together by a ring 24. A collar member 30 releasably encircles the dog's neck and side members 32, 34 connect the color 30 to the loops 14, 16, respectively. A leash 40 is attached to the ring 24.

A left cheek strap 50 is connected to the ring 16 and the ring 34. A right cheek strap 52 is connected to the ring 14 and the ring 32. A behind the ears strap 60 with an adjustable buckle 62 is connected to opposite ends thereof to the rings 32, 34, respectively. An under jaw strap 64 is connected to the ring 32 and the ring 34. An under chin strap 66 is sewn onto the center of the strap 64, then is doubled over going through the ring 22 and returning to the center of strap 64 to be sewn into the strap 64. The buckle 62 behind the ears is made of nickel plated aluminum or steel with an additional tie stay attached to hold down extra strapping.

When the halter is secured to a dog's head as shown in FIG. 2, tension applied to the leash will be primarily felt around the nose or muzzle area of the dog. The more tightly the leash is pulled, the more tightly the nose loop 12 will pull against the dog's muzzle. Thus, the handler has a secure grip of the dog's muzzle without causing pain or permanently restraining the dog from opening its mouth. The halter is self-adjusting to a certain degree, in that when the animal moves its head to one side or raises or lowers its head the side loop and collar members can move relative to one another to the extent allowed by the length of the connecting loops. This makes the halter more comfortable and less restricting for the dog and allows it to move its head more easily in response to the handler tensioning the leash.

Refer now to FIG. 2 where the nose loop 12 rests anywhere from ¼ inches to 2 inches below the eyes of the dog, depending on the breed of dog in which the training halter 10 is used. The under nose loop 20 is under the dog's jaw/chin and hangs loosely below this area, leaving the ring 24 for reception of the leash 40. The nose loop 12 connects with the ring 16 and doubles back upon itself a half inch and is sewn, as all the seams which attach to rings are constructed for strength and durability. All seams face outward away from the dog's fur surface. The left cheek strap 50 extends from the ring at the cheek to ring 16 near the dog's jaw. This can be of varying length, depending on the halter size and size of dog ring. The under jaw strap 64 extends from ring 34 down under the jaw to the ring 32 with under jaw/chin strap 66 connecting at the center of strap 64. Ring 22, under the dog's jaw is able to move from contact with the dog's jaw all the way down to the ring 24, offering the dog an opportunity to completely open his jaw. However, should the handler wish to correct the dog for aggression, the ring 22 can be fully retracted to hold the jaw closed with a temporary muzzle effect.

Refer now to FIG. 3. Ring 14 is shown with each strap 20, 50, 12 coming through the underside the side against the dog, through the ring 16, overlapped by one half an inch and then glued and sewn.

When used, the training halter according to the present invention applies pressure to the top of the nose of the dog wearing the training halter. Using the training halter, dogs fully understand that their handler is in charge and rarely object to anything asked of them. When the dog pulls ahead, the handler tugs down and turns. When the dog does not listen to the sit command or gets up from a sit stay, the handler pulls forward and upward, making the dog's head go up and rear end go down. Should a dog show aggression, the forward and upward pull will make him submissive by placing him in a submissive position, the sit. It can also be used to correct an aggressive dog, by holding the leash forward and upward as the handler applies the alpha stare (staring straight into the dog's eyes until he turns away). Dogs learn faster and in a more logical manner using canine language.

FIG. 4 is an alternate embodiment for short nosed dogs which differs from the FIGS. 1-3 embodiment in that the side straps 52 and 66 are shorter and the nose strap is thinner (¼ inch in diameter).

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A training halter for a dog, comprising:
an upper nose loop for applying pressure to the dog's nose;
a lower nose loop connected to said upper nose loop;
a collar member for encircling the dog's head; and
a pair of side members for securing the collar member to the upper and lower nose loops.

2. The training halter of claim 1, wherein said upper nose loop is made of a soft cotton/nylon braid.

3. The training halter of claim 2, wherein said upper nose loop is cylindrical.

4. The training halter of claim 1, wherein said lower nose loop and said side members are made of a flat braid nylon weave.

5. The training halter of claim 1, further comprising an under chin strap connected to said upper and lower nose loops at one end thereof and at an opposite end to said collar member.
